(19) United States
(12) Patent Application Publication
(10) Pub. No.: US 2025/0115810 A1
(43) Pub. Date: Apr. 10, 2025

(54) Liquid Crystalline Polymer Composition

(71) Applicant: Ticona LLC, Florence, KY (US)

(72) Inventor: Young Shin Kim, Cincinnati, OH (US)

(21) Appl. No.: 18/897,001

(22) Filed: Sep. 26, 2024

Related U.S. Application Data
(60) Provisional application No. 63/589,062, filed on Oct. 10, 2023.

(51) Int. Cl. C09K 19/38; C09K 19/02; C09K 19/52

(52) U.S. Cl. CPC C09K 19/3838; C09K 19/02; C09K 19/52

(57) ABSTRACT

A polymer composition comprising 100 parts by weight of a polymer matrix and from about 20 parts to about 150 parts by weight of an impact modifier is provided. The impact modifier includes a (meth)acrylic component that is derived from an epoxy-functionalized monomeric unit, non-epoxy functionalized (meth)acrylic monomeric component, or a combination thereof. Further, the impact modifier exhibits a Shore D hardness of about 75 or less.

### RELATED APPLICATION

The present application is based upon and claims priority to U.S. Provisional Patent Application Ser. No. 63/589,062, having a filing date of Oct. 10, 2023, which is incorporated herein by reference.

### BACKGROUND OF THE INVENTION

Camera modules (or components) are often employed in mobile phones, laptop computers, digital cameras, digital video cameras, etc. Generally, the camera module includes a lens unit and an image sensor for converting an image of an object into an electrical signal. The lens unit may be disposed in a housing unit and include a lens barrel having one or more lenses disposed therein. In addition, the camera module may include an actuator unit for optical image stabilization (OIS) to reduce resolution loss, or blurring, caused by hand-shake. The actuator unit functions by moving the lens unit to a target position after receiving a certain signal. To help ensure proper alignment of the lens unit during movement, many actuator units include ball bearings to help guide the lens unit in the desired direction. Conventionally, these ball bearings are formed from a ceramic material that is sufficiently strong to withstanding the forces exerted during use. While strong, the ball bearings can nevertheless cause dents and scratches to form on surfaces of the camera module, which create noise and impact performance. To help minimize these issues, camera modules often employ an elastic “damper” that acts as a shock absorbing agent to minimize damage to the surfaces of the camera module. Although elastic materials, such as natural rubber, can be good shock absorbing materials, it can nevertheless be difficult to apply such materials within the intricate spaces of a small camera module due to their inability to be readily molded. As such, a need currently exists for a material that can be flexible and yet still readily molded into a part with a small dimensional tolerance, such as for a damper of a camera module.

### SUMMARY OF THE INVENTION

In accordance with one embodiment of the present invention, a polymer composition is disclosed that comprises 100 parts by weight of a polymer matrix and from about 20 parts to about 150 parts by weight of an impact modifier. The impact modifier includes a (meth)acrylic component that is derived from an epoxy-functionalized monomeric unit, non-epoxy functional (meth)acrylic monomeric component, or a combination thereof. Further, the impact modifier exhibits a Shore D hardness of about 75 or less as determined in accordance with ISO 868:2003.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is an exploded perspective view of a camera module according to an exemplary embodiment in the present invention;

FIG. 2 is a combined perspective view of the camera module of FIG. 1;

FIG. 3 is a perspective view of the camera module of FIG. 2 in a state in which a shield can is removed therefrom;

FIG. 4 is a cut perspective view of the camera module of FIG. 2 taken along line A-A;

FIG. 5 is an enlarged cross-sectional view of portion B of FIG. 4, illustrating a modified state of a damper due to external impacts;

FIG. 6 is an enlarged perspective view of portion C of FIG. 4;

FIG. 7 is an enlarged cross-sectional view of portion C of FIG. 4, illustrating a modified state of a damper due to external impacts;

FIGS. 8A and 8B are cross-sectional views of dampers having other forms, respectively; and

FIGS. 9A and 9B are views of modified states of the dampers of FIG. 8, respectively.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a polymer composition that contains a polymer matrix including a liquid crystalline polymer and an impact modifier. By selectively controlling the particular nature of the polymer and impact modifier, as well as their relative concentration within the composition, the present inventor has discovered that the resulting composition can exhibit a high degree of flexibility and/or shock absorbing qualities, but still be readily molded or formed into parts having a small dimensional tolerance (e.g., camera module, cable, pipe, etc.).

The polymer composition may, for example, exhibit a tensile modulus of about 5,500 MPa or less, in some embodiments from about 500 MPa to about 5,200 MPa, in some embodiments from about 1,000 MPa to about 5,000 MPa, and in some embodiments, from about 1,500 MPa to about 4,500 MPa, as determined in accordance with ISO 527:2019 at 23° C. The tensile break strain (or elongation) may also be about 1% or more, in some embodiments from about 2% to about 15%, in some embodiments from about 3% to about 12%, and in some embodiments, from about 4% to about 10%, as determined in accordance with ISO 527:2019 at 23° C. Likewise, the composition may exhibit a flexural modulus of about 6,000 MPa or less, in some embodiments from about 500 MPa to about 5,800 MPa, in some embodiments from about 1,000 MPa to about 5,500 MPa, and in some embodiments, from about 2,000 MPa to about 5,000 MPa, as determined in accordance with ISO 178:2019 at 23° C. The polymer composition may also exhibit a Rockwell surface hardness of about 90 or less, in some embodiments about 75 or less, in some embodiments about 40 or less, in some embodiments about 30 or less, in some embodiments about 25 or less, and in some embodiments, from about 5 to about 20, as determined in accordance with ASTM D785-08 (Scale M). The ability to achieve such a tensile modulus, tensile break strain, flexural modulus, and/or Rockwell hardness may, among other things, help improve the softness and the flexibility of the composition so that it better serve as a shock absorbing material for use in applications requiring a small dimensional tolerance.

Of course, the polymer composition may still retain a high degree of strength. For example, the tensile strength of the composition may range from about 30 to about 250 MPa, in some embodiments from about 40 to about 230 MPa, and in some embodiments, from about 60 to about 200 MPa as determined in accordance with ISO 527:2019 at 23° C. Likewise, the polymer composition may exhibit a flexural strength of from about 30 to about 250 MPa, in some embodiments from about 40 to about 230 MPa, and in some embodiments, from about 60 to about 200 MPa, as determined in accordance with ISO 178:2019 at 23° C. The composition may also exhibit a high degree of impact strength, such as exhibited by a high Charpy notched impact strength of about 10 kJ/m² or more, in some embodiments about 20 kJ/m² or more, in some embodiments from about 40 to about 120 kJ/m², and in some embodiments, from about 50 to about 100 kJ/m², and/or a Charpy unnotched impact strength of about 5 kJ/m² or more, in some embodiments from about 10 to about 120 kJ/m², and in some embodiments, from about 15 to about 100 kJ/m² as measured at a temperature of 23° C. according to ISO 179-1:2010.

While possessing the properties of good softness, flexibility and strength, the polymer composition is also highly flowable, which can facilitate the ability of the composition to be used in parts having a very small thickness and/or overall size. The thickness of the part may, for example, be from 0.01 to about 5 millimeters, in some embodiments from about 0.05 to about 2.5 millimeters, and in some embodiments, from about 0.1 to about 1 millimeter. The polymer composition may exhibit a melt viscosity of about 300 Pa-s or less, in some embodiments about 250 Pa-s or less, in some embodiments from about 5 to about 200 Pa-s, in some embodiments from about 10 to about 150 Pa-s, and in some embodiments, from about 20 to about 100 Pa-s, as determined at a shear rate of 1,000 s⁻¹ in accordance with ISO 11443:2021 at a temperature that is 15° C. higher than the melting temperature of the composition. The heat resistance of the polymer composition may also be good. For example, the melting temperature of the composition and/or liquid crystalline polymer(s) used in the polymer matrix may be about 200° C. or more, in some embodiments about from about 210° C. to about 360° C., and in some embodiments, from about 260° C. to about 340° C. Further, the deflection temperature under load (DTUL) may be about 70° C. or more, in some embodiments about 80° C. or more, in some embodiments about 90° C. or more, in some embodiments about 100° C. or more, and in some embodiments, from about 110° C. to about 160° C., as measured according to ASTM D648-18 (technically equivalent to ISO 75-2:2013) at a specified load of 1.8 MPa.

Various embodiments of the present invention will now be described in more detail.

### I. Polymer Composition

### A. Polymer Matrix

The polymer matrix typically constitutes from about 30 wt. % to about 90 wt. %, in some embodiments from about 35 wt. % to about 85 wt. %, in some embodiments from about 40 wt. % to about 80 wt. %, and in some embodiments, from about 45 wt. % to about 75 wt. % of the polymer composition. As indicated above, the polymer matrix generally contains a liquid crystalline polymer. Liquid crystalline polymers are generally classified as “thermotropic” to the extent that they can possess a rod-like structure and exhibit a crystalline behavior in their molten state (e.g., thermotropic nematic state). Such polymers may be formed from one or more types of repeating units as is known in the art. A liquid crystalline polymer may, for example, contain one or more aromatic ester repeating units generally represented by the following Formula (I):

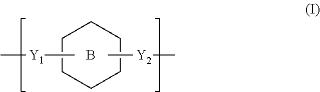

wherein,
ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and
Y₁ and Y₂ are independently O, C(O), NH, C(O)HN, or NHC(O).

Typically, at least one of Y₁ and Y₂ are C(O). Examples of such aromatic ester repeating units may include, for instance, aromatic dicarboxylic repeating units (Y₁ and Y₂ in Formula I are C(O)), aromatic hydroxycarboxylic repeating units (Y₁ is O and Y₂ is C(O) in Formula I), as well as various combinations thereof.

Aromatic hydroxycarboxylic repeating units, for instance, may be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute about 30 mol. % or more, in some embodiments from about 50 mol. % to 100 mol. %, and in some embodiments, from about 70 mol. % to 100 mol. % of the polymer.

In certain embodiments, the liquid crystalline polymer may contain only components derived from aromatic hydroxycarboxylic repeating units, such as HBA and HNA. In other embodiments, however, aromatic dicarboxylic repeating units may also be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) each typically constitute from about 1 mol. % to about 50 mol. %, in some embodiments from about 2 mol. % to about 40 mol. %, and in some embodiments, from about 5 mol. % to about 30 mol. % of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”) When employed, repeating units derived from aromatic diols (e.g., HQ and/or BP) each typically constitute from about 1 mol. % to about 30 mol. %, in some embodiments from about 2 mol. % to about 25 mol. %, and in some embodiments, from about 5 mol. % to about 20 mol. % of the polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10 mol. % of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

In some embodiments, the polymer matrix may contain a “low naphthenic” liquid crystalline polymer having a low content of repeating units derived from naphthenic hydroxycarboxylic acids and naphthenic dicarboxylic acids, such as naphthalene-2,6-dicarboxylic acid (“NDA”), 6-hydroxy-2-naphthoic acid (“HNA”), or combinations thereof. That is, the total amount of repeating units derived from naphthenic hydroxycarboxylic and/or dicarboxylic acids (e.g., NDA, HNA, or a combination of HNA and NDA) can be about 15 mol. % or less, in some embodiments about 10 mol. % or less, in some embodiments about 6 mol. % or less, and in some embodiments, from 0 mol. % to about 5 mol. % of the polymer. In such embodiments, the polymer may contain repeating units derived from HBA in an amount of from about 40 mol. % to about 80 mol. %, and in some embodiments from about 45 mol. % to about 75 mol. %, and in some embodiments, from about 50 mol. % to about 70 mol. %. The polymer may also contain aromatic dicarboxylic acid(s) (e.g., IA and/or TA) in an amount of from about 1 mol. % to about 26 mol. %, and in some embodiments, from about 5 mol. % to about 20 mol. %, and/or aromatic diol(s) (e.g., BP and/or HQ) in an amount of from about 1 mol. % to about 20 mol. %, and in some embodiments, from about 4 mol. % to about 15 mol. %.

In other embodiments, the polymer matrix may contain a “high naphthenic” liquid crystalline polymer containing a relatively high content of repeating units derived from naphthenic hydroxycarboxylic acids and naphthenic dicarboxylic acids, such as naphthalene-2,6-dicarboxylic acid (“NDA”), 6-hydroxy-2-naphthoic acid (“HNA”), or combinations thereof. That is, the total amount of repeating units derived from naphthenic hydroxycarboxylic and/or dicarboxylic acids (e.g., NDA, HNA, or a combination of HNA and NDA) can be greater than about 15 mol. %, in some embodiments about 18 mol. % or more, and in some embodiments, from about 20 mol. % to about 60 mol. % of the polymer. In one particular embodiment, for instance, the repeating units derived from 6-hydroxy-2-naphthoic acid (“HNA”) may constitute from about 10 mol. % to about 40 mol. %, in some embodiments from about 15 mol. % to about 35 mol. %, and in some embodiments, from about 20 mol. % to about 30 mol. % of the polymer. In such embodiments, the liquid crystalline polymer may also contain various other monomers, such as aromatic hydroxycarboxylic acid(s) (e.g., HBA) in an amount of from about 20 mol. % to about 85 mol. %, in some embodiments from about 40 mol % to about 82 mol % and in some embodiments, from about 70 mol. % to about 80 mol. %. The polymer may also contain aromatic dicarboxylic acid(s) (e.g., IA and/or TA), such as in an amount of from about 0 mol. % to about 30 mol. %, and in some embodiments, from about 2 mol. % to about 25 mol. %, and/or aromatic diol(s) (e.g., BP and/or HQ), such as in an amount of from about 0 mol. % to about 40 mol. %, and in some embodiments, from about 2 mol. % to about 35 mol. %. In some embodiments, the high naphthenic liquid crystalline polymer contains a small amount of aromatic dicarboxylic acid in addition to a naphthenic hydroxycarboxylic acid and HBA. For instance, the liquid crystalline polymer can contain TA and/or IA in an amount from about 0.1 mol. % to about 5 mol. %, in some embodiments from about 0.2 mol. % to about 2 mol. %, and in some embodiments, from about 0.5 mol. % to about 1 mol. %.

In certain embodiments, all of the liquid crystalline polymers are “low naphthenic” polymers such as described above. In other embodiments, all of the liquid crystalline polymers are “high naphthenic” polymers such as described above. In some cases, blends of such polymers may also be used. For example, high naphthenic liquid crystalline polymers may constitute from about 50 wt. % to about 95 wt. %, in some embodiments from about 60 wt. % to about 90 wt. %, and in some embodiments, from about 75 wt. % to about 85 wt. % of the total amount of liquid crystalline polymers in the composition, and low naphthenic liquid crystalline polymers may constitute from about 5 wt. % to about 50 wt. %, in some embodiments from about 10 wt. % to about 40 wt. %, and in some embodiments, from about 15 wt. % to about 25 wt. % of the total amount of liquid crystalline polymers in the composition. In other embodiments, low naphthenic liquid crystalline polymers may constitute from about 50 wt. % to about 99 wt. %, in some embodiments from about 80 wt. % to about 97 wt. %, and in some embodiments, from about 90 wt. % to about 95 wt. % of the total amount of liquid crystalline polymers in the composition, and high naphthenic liquid crystalline polymers may constitute from about 1 wt. % to about 50 wt. %, in some embodiments from about 3 wt. % to about 20 wt. %, and in some embodiments, from about 5 wt. % to about 10 wt. % of the total amount of liquid crystalline polymers in the composition.

### B. Impact Modifier

As indicated above, an impact modifier is also employed within the polymer composition. Typically, impact modifier(s) constitute from about 20 parts to about 150 parts, in some embodiments from about 25 to about 130 parts, and in some embodiments, from about 30 to about 120 parts by weight per 100 parts by weight of the polymer matrix. For example, the impact modifiers may constitute from about 15 wt. % to about 50 wt. %, in some embodiments from about 18 wt. % to about 45 wt. %, and in some embodiments, from about 20 wt. % to about 40 wt. % of the polymer composition.

To help impart the desired combination of softness, flexibility, and scratch resistance, it is generally desired that the impact modifier is a polymer that contains a (meth)acrylic component. As used herein, the term “(meth)acrylic” includes acrylic and methacrylic monomers, as well as salts or esters thereof, such as acrylate and methacrylate monomers. The (meth)acrylic component may, for example, constitute from about 5 wt. % to about 45 wt. %, in some embodiments from about 10 wt. % to about 42 wt. %, and in some embodiments, from about 20 wt. % to about 40 wt. % of the impact modifier.

The (meth)acrylic component may be derived from one or more types of monomeric components. In one embodiment, for example, the (meth)acrylic component may be derived entirely or in part from an “epoxy-functionalized” (meth)acrylic component. The term “epoxy-functionalized” generally means that the component contains, on average, two or more epoxy functional groups per molecule. For example, suitable epoxy-functionalized (meth)acrylic monomers may include, but are not limited to, those containing 1,2-epoxy groups, such as glycidyl acrylate and glycidyl methacrylate. Other suitable epoxy-functionalized monomers include allyl glycidyl ether, glycidyl ethacrylate, and glycidyl itoconate. When employed, the epoxy-functionalized (meth)acrylic monomer(s) typically constitute from about 1 wt. % to about 35 wt. %, in some embodiments from about 2 wt. % to about 20 wt. %, and in some embodiments, from about 4 wt. % to about 12 wt. % of the impact modifier.

Of course, (meth)acrylic monomer(s) may also be employed that are not epoxy-functionalized. Examples of such (meth)acrylic monomers may include methyl acrylate, ethyl acrylate, propyl acrylate (e.g., n-propyl acrylate, i-propyl acrylate, etc.), butyl acrylate (e.g., n-butyl acrylate, s-butyl acrylate, i-butyl acrylate, t-butyl acrylate, etc.), amyl acrylate (e.g., n-amyl acrylate, i-amyl acrylate, etc.), isobornyl acrylate, hexyl acrylate (e.g., n-hexyl acrylate), 2-ethylbutyl acrylate, 2-ethylhexyl acrylate, octyl acrylate (e.g., n-octyl acrylate), decyl acrylate (e.g., n-decyl acrylate), methylcyclohexyl acrylate, cyclopentyl acrylate, cyclohexyl acrylate, methyl methacrylate, ethyl methacrylate, 2-hydroxyethyl methacrylate, propyl methacrylate (e.g., n-propyl methacrylate, i-propyl methacrylate, etc.), butyl methacrylate (e.g., n-butyl methacrylate, i-butyl methacrylate, t-butyl methacrylate, etc.), amyl methacrylate (e.g., n-amyl methacrylate, i-amyl methacrylate, etc.), hexyl methacrylate (e.g., n-hexyl methacxrylate), 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. When employed, the non-epoxy-functionalized (meth)acrylic monomer(s) typically constitute from about 5 wt. % to about 40 wt. %, in some embodiments from about 10 wt. % to about 35 wt. %, and in some embodiments, from about 15 wt. % to about 30 wt. % of the impact modifier.

The impact modifier may also contain an olefinic monomeric unit that is derived from one or more α-olefins. When employed, such α-olefin monomer(s) typically constitute from about 50 wt. % to about 90 wt. %, in some embodiments from about 60 wt. % to about 85 wt. %, and in some embodiments, from about 65 wt. % to about 75 wt. % of the copolymer. Examples of such monomers include, for instance, linear and/or branched α-olefins having from 2 to 20 carbon atoms and typically from 2 to 8 carbon atoms. Specific examples include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin monomers are ethylene and propylene.

In one particular embodiment, for example, the impact modifier may be a random copolymer of an olefinic monomer (e.g., ethylene) and an epoxy-functionalized (meth)acrylic monomer (e.g., glycidyl methacrylate). One commercially available example of such an impact modifier is Lotader® AX8840 (8 wt. % glycidyl methacrylate and 92 wt. % ethylene). In another embodiment, the impact modifier may be a terpolymer formed from an olefin monomer (e.g., ethylene), an epoxy-functionalized (meth)acrylic monomer (e.g., glycidyl methacrylate), and a non-epoxy functionalized (meth)acrylic monomer (e.g., butyl acrylate, methyl acrylate, butyl methacrylate, methyl methacrylate, etc.). Commercially available examples of such impact modifiers include Elvaloy® PTW (5 wt. % glycidyl methacrylate, 28 wt. % butyl acrylate, and 67 wt. % ethylene), Lotader® AX8900 (8 wt. % glycidyl methacrylate, 24 wt. % methyl acrylate, 68 wt. % ethylene), Lotader® AX8750 (5 wt. % glycidyl methacrylate, 25 wt. % butyl acrylate, and 70 wt. % ethylene), and Lotader® AX8750T (5 wt. % glycidyl methacrylate, 27 wt. % butyl acrylate, and 68 wt. % ethylene).

The resulting melt flow index of the impact modifier may vary, but is typically from about 1 to about 50 grams per 10 minutes (“g/10 min”), in some embodiments from about 2 to about 40 g/10 min, and in some embodiments, from about 3 to about 25 g/10 min, as determined in accordance with ISO 1133-1:2022 at a load of 2.16 kg and temperature of 190° C.

### C. Inorganic Filler

Although by no means required, the polymer composition may also contain an inorganic filler that is distributed within the polymer matrix. Such fillers generally constitute from about 10 wt. % to about 40 wt. %, in some embodiments from about 15 wt. % to about 38 wt. %, and in some embodiments, from about 20 wt. % to about 35 wt. % of the polymer composition. Any of a variety of different types of inorganic fillers may generally be employed, such as those formed from a natural and/or synthetic silicate mineral, such as talc, mica, halloysite, kaolinite, illite, montmorillonite, vermiculite, palygorskite, pyrophyllite, calcium silicate, aluminum silicate, wollastonite, etc.; sulfates; carbonates; phosphates; fluorides, borates; and so forth. In certain cases, the inorganic filler may have a certain hardness value to help improve the mechanical strength, adhesive strength, and surface properties of the composition, which enables the composition to be uniquely suited to form small components, such as in a camera module. For instance, the hardness values may be about 2.0 or more, in some embodiments about 2.5 or more, in some embodiments about 3.0 or more, in some embodiments from about 3.0 to about 11.0, in some embodiments from about 3.5 to about 11.0, and in some embodiments, from about 4.5 to about 6.5 based on the Mohs hardness scale.

The nature of the inorganic filler may also vary as desired. In one embodiment, for instance, the polymer composition may contain inorganic filler particles that are distributed within the polymer matrix. For instance, the particles may be formed from a natural and/or synthetic mineral, such as talc, mica, halloysite, kaolinite, illite, montmorillonite, vermiculite, palygorskite, pyrophyllite, calcium silicate, aluminum silicate, wollastonite, etc. Other suitable inorganic filler particles may include, for instance, barium sulfate, calcium sulfate, silica, alumina, calcium carbonate, etc. The particles may possess a variety of different forms and shapes depending upon the desired performance. For instance, the particles may be in the shape of a sphere, crystal, rod, disk, tube, string, etc. In one embodiment, for example, the particles may be generally spherical in that the aspect ratio (ratio of the median diameter to the thickness) is from about 0.7 to about 1.3, in some embodiments from about 0.8 to about 1.2, in some embodiments from about 0.9 to about 1.1 (e.g., 1). Regardless of their particular shape, however, the particles are generally selectively controlled to have a certain a median (D50) diameter, such as about 5 micrometers or less, in some embodiments from about 0.01 to about 4 micrometers, in some embodiments from about 0.05 to about 3 micrometers, and in some embodiments, from about 0.1 to about 2.5 micrometers, such as determined by a laser diffraction particle size analyzer (e.g., Mastersizer 3000) or sedimentation analysis (e.g., Sedigraph 5120). The particles may also have a narrow size distribution. That is, at least about 70% by volume of the particles, in some embodiments at least about 80% by volume of the particles, and in some embodiments, at least about 90% by volume of the particles may have a size within the ranges noted above. Furthermore, within the general size ranges noted above, it may sometimes be desirable to employ a blend of particles having different sizes to achieve the target properties. The particles may also have a controlled specific surface area, such as from about 1 to about 50 square meters per gram (m²/g), in some embodiments from about 2 to about 20 m²/g, and in some embodiments, from about 4 to about 12 m²/g. The term “specific surface area” generally refers to surface area as determined by the physical gas adsorption (B.E.T.) method of Bruanauer, Emmet, and Teller, Journal of American Chemical Society, Vol. 60, 1938, p. 309, with nitrogen as the adsorption gas. The moisture content may also be relatively low, such as about 5% or less, in some embodiments about 3% or less, and in some embodiments, from about 0.1 to about 1% as determined in accordance with ISO 787-2:1981 at a temperature of 105° C.

Various other types of inorganic fillers may also be employed in the polymer composition. In one embodiment, for instance, mineral fibers (or “whiskers”) may be employed, such as those that are derived from silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Particularly suitable are fibers derived from inosilicates, such as wollastonite, which are commercially available from Nyco Minerals under the trade designation Nyglos® (e.g., Nyglos® 4 W or Nyglos® 8). The mineral fibers may have a median diameter of from about 1 to about 35 micrometers, in some embodiments from about 2 to about 20 micrometers, in some embodiments from about 3 to about 15 micrometers, and in some embodiments, from about 7 to about 12 micrometers. In addition to possessing the size characteristics noted above, the mineral fibers may also have a relatively high aspect ratio (average length divided by median diameter) to help further improve the mechanical properties and surface quality of the resulting polymer composition. For example, the mineral fibers may have an aspect ratio of from about 2 to about 100, in some embodiments from about 2 to about 50, in some embodiments from about 3 to about 20, and in some embodiments, from about 4 to about 15. The volume average length of such mineral fibers may, for example, range from about 1 to about 200 micrometers, in some embodiments from about 2 to about 150 micrometers, in some embodiments from about 5 to about 100 micrometers, and in some embodiments, from about 10 to about 50 micrometers.

### D. Other Components

A wide variety of additional additives can also be included in the polymer composition, such as lubricants, thermally conductive fillers, pigments (e.g., carbon black), flow modifiers, antioxidants, stabilizers, surfactants, waxes, flame retardants, anti-drip additives, nucleating agents, and other materials added to enhance properties and processability. Lubricants, for example, may be employed in the polymer composition that are capable of withstanding the processing conditions of the liquid crystalline polymer without substantial decomposition. Examples of such lubricants include fatty acids esters, the salts thereof, esters, fatty acid amides, organic phosphate esters, and hydrocarbon waxes of the type commonly used as lubricants in the processing of engineering plastic materials, including mixtures thereof. Suitable fatty acids typically have a backbone carbon chain of from about 12 to about 60 carbon atoms, such as myristic acid, palmitic acid, stearic acid, arachic acid, montanic acid, octadecinic acid, parinric acid, and so forth. Suitable esters include fatty acid esters, fatty alcohol esters, wax esters, glycerol esters, glycol esters and complex esters. Fatty acid amides include fatty primary amides, fatty secondary amides, methylene and ethylene bisamides and alkanolamides such as, for example, palmitic acid amide, stearic acid amide, oleic acid amide, N,N′-ethylenebisstearamide and so forth. Also suitable are the metal salts of fatty acids such as calcium stearate, zinc stearate, magnesium stearate, and so forth; hydrocarbon waxes, including paraffin waxes, polyolefin and oxidized polyolefin waxes, and microcrystalline waxes. Particularly suitable lubricants are acids, salts, or amides of stearic acid, such as pentaerythritol tetrastearate, calcium stearate, or N,N′-ethylenebisstearamide. When employed, the lubricant(s) typically constitute from about 0.05 wt. % to about 1.5 wt. %, and in some embodiments, from about 0.1 wt. % to about 0.5 wt. % (by weight) of the polymer composition.

One beneficial aspect of the present invention is that good mechanical properties may be achieved without adversely impacting the dimensional stability of the resulting part. To help ensure that this dimensional stability is maintained, it is generally desirable that the polymer composition remains substantially free of conventional fibrous fillers, such as glass fibers. Thus, if employed at all, glass fibers typically constitute no more than about 10 wt. %, in some embodiments no more than about 5 wt. %, and in some embodiments, from about 0.001 wt. % to about 3 wt. % of the polymer composition.

Regardless of the components employed, they may be combined together using any of a variety of different techniques as is known in the art. In one particular embodiment, for example, the liquid crystalline polymer, impact modifier, and other optional additives are melt processed as a mixture within an extruder to form the polymer composition. The mixture may be melt-kneaded in a single-screw or multi-screw extruder, such as at a temperature of from about 210° C. to about 360° C. In one embodiment, the mixture may be melt processed in an extruder that includes multiple temperature zones. The temperature of individual zones is typically set within about −60° C. to about 25° C. relative to the melting temperature of the polymer. By way of example, the mixture may be melt processed using a twin screw extruder such as a Leistritz 18-mm co-rotating fully intermeshing twin screw extruder. A general purpose screw design can be used to melt process the mixture. In one embodiment, the mixture including all of the components may be fed to the feed throat in the first barrel by means of a volumetric feeder. In another embodiment, different components may be added at different addition points in the extruder, as is known. For example, the polymer may be applied at the feed throat, and certain additives (e.g., impact modifier) may be supplied at the same or different temperature zone located downstream therefrom. Regardless, the resulting mixture can be melted and mixed then extruded through a die. The extruded polymer composition can then be quenched in a water bath to solidify and granulated in a pelletizer followed by drying.

### II. Shaped Components

The polymer composition may be readily shaped into a component for use in various product applications. The shaped component may be formed using a variety of different techniques, such as melt extrusion, three-dimensional printing, molding, etc. Suitable molding techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polymer composition into the desired article also occurs within a mold. The composition may be placed into the compression mold using any known technique, such as by being picked up by an automated robot arm. The temperature of the mold may be maintained at or above the solidification temperature of the polymer matrix for a desired time period to allow for solidification. The molded product may then be solidified by bringing it to a temperature below that of the melting temperature. The resulting product may be de-molded. The cycle time for each molding process may be adjusted to suit the polymer matrix, to achieve sufficient bonding, and to enhance overall process productivity.

### III. Product Applications

The polymer composition of the present invention may be employed in any desired product application. As noted above, however, the polymer composition is particularly well suited for use in shaped components for product applications in which there is a need for a flexible and soft material (e.g., shock absorbing) and in which the component has a small dimensional tolerance. In certain embodiments, for example, the polymer composition may be employed as a sealing gasket in a wide variety of products. For instance, the sealing gasket may be employed in a fuel cell, which may be integrated with a membrane-electrode assembly, gas diffusion layer, separator or a polymer frame, as a component of a fuel cell stack. The fuel cell may, for example, contain a membrane electrode assembly sandwiched between separators to serve as a unit for power generation. The fuel cell is configured by stacking a number of cells. A frame-shaped rubber gasket, which may be formed from the polymer composition described herein, may be arranged at the periphery of the electrode member and between the adjacent separators to ensure sealability and insulating property with respect to gas and cooling medium.

Other products applications may likewise include, for instance, tubular members having a relatively small size (e.g., cables, pipes, etc.). Sheet-like products, such as films, fibrous materials, thermoformed sheets, etc., may also be formed from the polymer composition of the present invention. The sheet-like product may be formed from known techniques, such as by melt-extrusion, three-dimensional printing, etc. In one embodiment, for example, the sheet-like product may be employed in a printed circuit board. The printed circuit board may, for instance, contain a conductive layer (e.g., copper layer) that overlies a film or fibrous material formed from the polymer composition of the present invention.

Still other product applications include electronic devices or components of such devices (e.g., camera modules, lighting devices, etc.), such as portable electronic devices (e.g., mobile phones, portable computers, tablets, watches, etc.), computers, televisions, automotive parts, etc. In one particular embodiment, the polymer composition may be employed in a camera module, such as those commonly employed in wireless communication devices (e.g., cellular telephone). In one embodiment, for example, the polymer composition may be employed in a camera module that includes a lens unit mounted in a housing unit and an actuator unit that is configured to allow relative movement of the lens unit with respect to the housing unit. If desired, the polymer composition of the present invention may be employed in an element of the camera module, such as in the lens unit and/or actuator unit. The camera module may also contain one or more dampers disposed between the housing unit and the lens unit, which is configured to help act as a shock absorbing material to minimize the formation of dents and/or scratches on a surface of the camera module caused by collision of portions of the module (e.g., lens unit, housing unit, ball members, etc.), as well as help reduce noise.

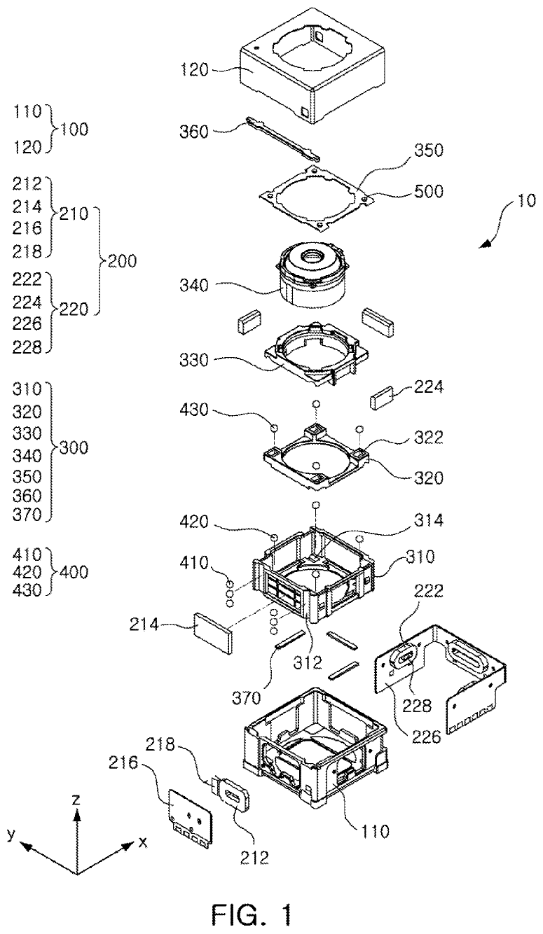

Referring to FIG. 1, one particular embodiment of a camera module 10 is shown in more detail that contains a housing unit 100, actuator unit 200, lens unit 300, and one or more dampers 500. The housing unit 100 may include a housing 110 and a shield can 120. The housing 110 may be formed from any moldable material, including the polymer composition of the present invention. One or more actuator units 200 may be mounted in the housing 110. For example, a portion of a first actuator 210 may be mounted on a first side surface of the housing 110, and portions of a second actuator 220 may be mounted on second through fourth side surfaces of the housing 110, respectively. The housing 110 may be configured to accommodate the lens unit 300 therein. For example, an accommodation space for entirely or partially accommodating the lens unit 300 therein may be formed inside the housing 110. The housing 110 may have six surfaces including openings formed therein, respectively. For example, the housing 110 may have a bottom surface in which a rectangular opening for an image sensor is formed, and may have a top surface in which a square opening for mounting the lens unit 300 therein is formed. In addition, the housing 110 may have the first side surface in which an opening for inserting a first coil 212 of the first actuator 210 thereto is formed, and may have the second through fourth side surfaces in which openings for inserting second coils 222 of the second actuator 220 thereto are formed, respectively. The shield can 120 may be configured to cover a portion of the housing 110. For example, the shield can 120 may be configured to cover the top surface of the housing 110 and the four side surfaces of the housing 110. However, a shape of the shield can 120 is not limited to a shape to cover all of the above-described portions. For example, the shield can 120 may be configured to only cover the four side surfaces of the housing 110. Alternatively, the shield can 120 may be configured to partially cover the top surface of the housing 110 and the four side surfaces of the housing 110.

The actuator unit 200 may be configured to move the lens unit 300 in one or more directions. For example, the actuator unit 200 may be configured to move the lens unit 300 in a direction of an optical axis (Z axis direction with reference to FIG. 1) and directions (X axis direction and Y axis direction with reference to FIG. 1) perpendicular with respect to the optical axis. The actuator unit 200 may include a plurality of actuator units. As an example, the actuator unit 200 may include the first actuator 210 configured to move the lens unit 300 in the Z axis direction (with reference to FIG. 1) and the second actuator 220 configured to move the lens unit 300 in the X axis direction and the Y axis direction (with reference to FIG. 1).

The first actuator 210 may be mounted in the housing 110 and a first frame 310 of the lens unit 300. For example, a portion of the first actuator 210 may be mounted on the first side surface of the housing 110 and a remaining portion of the first actuator 210 may be mounted on a first side surface of the first frame 310. The first actuator 210 may include an element for moving the lens unit 300 in the direction of the optical axis. As an example, the first actuator 210 may include the first coil 212, a first permanent magnet 214, a first substrate 216, and a first sensor 218. The first coil 212 and the first sensor 218 may be formed on the first substrate 216. The first substrate 216 may be mounted on the first side surface of the housing 110, and the first permanent magnet 214 may be mounted on the first side surface of the first frame 310 facing the first substrate 216. The first actuator 210 may allow relative movement of the first frame 310 and a lens barrel 340 with respect to the housing 110 by changing intensity and a direction of magnetic force generated between the first coil 212 and the first permanent magnet 214. In addition, the first actuator 210 may detect a position of the first frame 310 based on a change in a magnetic flux detected by the first sensor 218.

The second actuator 220 may be mounted in the housing 110 and a third frame 330 of the lens unit 300. For example, portions of the second actuator 220 may be mounted on the second through fourth side surfaces of the housing 110, respectively, and a remaining portion of the second actuator 220 may be mounted on second through fourth side surfaces of the third frame 330. The second actuator 220 may include an element for moving the lens unit 300 in the direction perpendicular with respect to the optical axis. As an example, the second actuator 220 may include a plurality of second coils 222, a plurality of second permanent magnets 224, a second substrate 226, and one or more second sensors 228. The plurality of second coils 222 and the one or more second sensors 228 may be formed on the second substrate 226. The second substrate 226 may be generally formed to be mounted to surround the second through fourth side surfaces of the housing 110. The plurality of second permanent magnets 224 may be mounted on the second through fourth side surfaces of the third frame 330 to face three surfaces of the second substrate 226, respectively. The second actuator 220 may allow relative movement of the second frame 320 and the third frame 330 with respect to the first frame 310 by changing intensity and a direction of magnetic force generated between the plurality of second coils 222 and the plurality of second permanent magnets 224. For reference, the lens barrel 340 may move in the same direction as that of the second frame 320 and the third frame 330 by movement of the second frame 320 and the third frame 330. The second actuator 220 may detect positions of the second frame 320 and the third frame 330 based on a change in a magnetic flux detected by the second sensor 228.

The lens unit 300 may be mounted in the housing unit 100. For example, the lens unit 300 may be accommodated in an accommodation space formed by the housing 110 and the shield can 120 in a manner in which the lens unit 300 may move in at least three axis directions. The lens unit 300 may contain a plurality of frames. For example, the lens unit 300 may include the first frame 310, the second frame 320, and the third frame 330.

The first frame 310 may be configured to move with respect to the housing 110. As an example, the first frame 310 may move in a height direction (Z axis direction with reference to FIG. 1) of the housing 110 by the first actuator 210. A plurality of guide grooves 312 and 314 may be formed in the first frame 310. As an example, the first guide grooves 312 elongatedly formed to extend in the direction of the optical axis (Z axis direction with reference to FIG. 1) may be formed in the first side surface of the first frame 310, and the second guide grooves 314 elongatedly formed to extend in a direction (Y axis direction with reference to FIG. 1). The first frame 310 may be manufactured to have at least three side surfaces including openings formed therein, respectively. For example, the second through fourth side surfaces of the first frame 310 may include respective openings such that the second permanent magnets 224 of the third frame 330 exposed through the openings may face the second coils 222 of the housing 110, respectively. The second frame 320 may be mounted in the first frame 310. For example, the second frame 320 may be mounted in an interior of the first frame 310. The second frame 320 may be configured to move in the direction perpendicular with respect to the optical axis, with respect to the first frame 310. For example, the second frame 320 may move in the direction (Y axis direction with reference to FIG. 1) perpendicular with respect to the optical axis along the second guide grooves 314 of the first frame 310. A plurality of third guide grooves 322 may be formed in the second frame 320. For example, four third guide grooves 322 elongatedly formed to extend in a direction (X axis direction with reference to FIG. 1) perpendicular with respect to the optical axis may be formed in corners of the second frame 320, respectively.

The third frame 330 may be mounted in the second frame 320. For example, the third frame 330 may be mounted on a top surface of the second frame 320. The third frame 330 may be configured to move in the direction perpendicular with respect to the optical axis, with respect to the second frame 320. For example, the third frame 330 may move in the direction (X axis direction with reference to FIG. 1) perpendicular with respect to the optical axis along the third guide grooves 322 of the second frame 320. The plurality of second permanent magnets 224 may be mounted in the third frame 330. For example, three third permanent magnets 224 may be mounted in the second through fourth side surfaces of the third frame 330, respectively.

The lens unit 300 may include a lens barrel 340 that contains one or more lenses. The lens barrel 340 may be mounted in the third frame 330. For example, the lens barrel 340 may be inserted into the third frame 330 to move integrally with the third frame 330. The lens barrel 340 may be configured to move in the direction of the optical axis and the direction perpendicular with respect to the optical axis. For example, the lens barrel 340 may move in the direction of the optical axis by the first actuator 210, and may move in the direction perpendicular with respect to the optical axis by the second actuator 220.

The lens unit 300 may further include a cover member 350, a ball stopper 360, and a magnetic body 370. The cover member 350 may be configured to prevent the second frame 320 and the third frame 330 from escaping from the interior of the first frame 310. For example, the cover member 350 may be combined with the first frame 310 to suppress escaping of the second frame 320 and the third frame 330 upwardly of the first frame 310. The ball stopper 360 may be mounted in the first frame 310. The ball stopper 360 may be disposed to obscure the first guide grooves 312 of the first frame 310 to suppress escaping of first ball members 410 mounted in the first guide grooves 312 therefrom.

The magnetic body 370 may be mounted in the first frame 310. For example, the magnetic body 370 may be mounted in at least one of the second through fourth side surfaces of the first frame 310 to generate magnetic attractive force between the second coil 222 and the second permanent magnet 224 of the second actuator 220. The magnetic body 370 configured as above may fix positions of the second frame 320 and the third frame 330 with respect to the first frame 310 in an inactive state of the actuator unit 200. For example, the lens unit 300 may be maintained at a predetermined position inside the housing 110 by magnetic attractive force between the magnetic body 370 and the second coil 222.

The ball member 400 may be configured to smoothly move the lens unit 300. For example, the ball member 400 may be configured to smoothly move the lens unit 300 in the direction of the optical axis and the direction perpendicular with respect to the optical axis. The ball member 400 may be divided into first ball members 410, second ball members 420, and third ball members 430 based on a disposition position. As an example, the first ball members 410 may be disposed in each of the first guide grooves 312 of the first frame 310 to smoothly move the first frame 310 in the direction of the optical axis. As another example, the second ball member 420 may be disposed in each of the second guide grooves 314 of the first frame 310 to smoothly move the second frame 320 in a direction perpendicular with respect to the optical axis. As still another example, the third ball member 430 may be disposed in each of the third guide grooves 322 of the second frame 320 to smoothly move the third frame 330 in another direction perpendicular with respect to the optical axis. For reference, although not illustrated in FIG. 1, a viscous fluid (e.g., lubricant) may be filled in all portions of the camera module 10 in which the ball member 400 is disposed. For example, the viscous fluid may be injected into each of the guide grooves 312, 314, and 322. Of course, in other embodiments, the polymer composition may be employed in place of the viscous fluid.

As noted above, the camera module 10 also contains one or more dampers 500. Each damper 500 may be configured to reduce noise and/or surface damage caused by collision of portions of the camera module, such as by movement of the lens unit 300. For example, the damper 500 may be configured to reduce collision damage and/or noise caused by moving the lens unit 300 in the direction of the optical axis and the direction perpendicular with respect to the optical axis due to external impacts. As an example, the damper 500 may be formed in the cover member 350 to reduce collision noise and/or damage generated between the lens unit 300 and the housing unit 100.

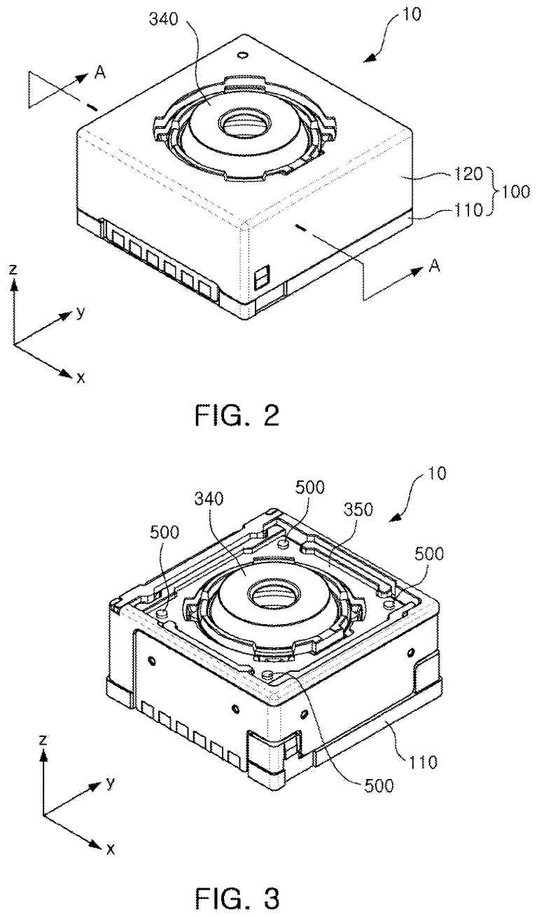

Referring to FIG. 2, a combined form of the camera module 10 will be described. The camera module 10 may have both an auto-focusing function and an optical image stabilization (OIS) function. For example, the lens barrel 340 may move in the direction of the optical axis and the direction perpendicular with respect to the optical axis inside the housing unit 100. Thus, the miniaturization and the slimming of the camera module 10 according to the present exemplary embodiment may be relatively easily achieved.

Referring to FIG. 3, the camera module 10 in a state in which the shied can 120 is removed therefrom will be described. The camera module 10 may include one or more dampers 500. As an example, the one or more dampers 500 may be formed in the cover member 350 of the lens unit 300 as illustrated in FIG. 3. The dampers 500 formed as above may reduce noise and/or damage due to vibrations of the lens barrel 340 caused by rapid movement of the lens barrel 340 or external impacts. As an example, the dampers 500 may reduce impacts and collision noise generated when the cover member 350 of the first frame 310 and the shield can 120 collide, due to vibrations of the lens barrel 340.

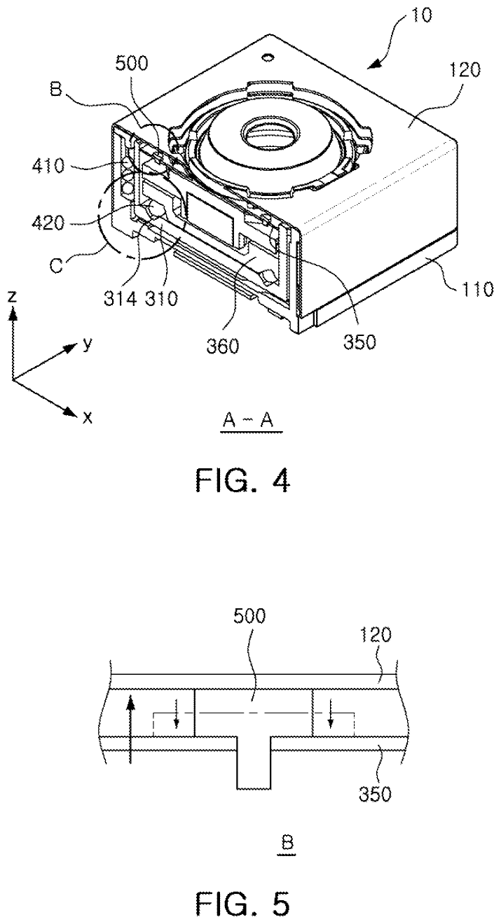

Referring to FIG. 4, a cross-sectional structure of the camera module 10 will be described. For example, the first frame 310 may be in point contact with the housing 110 by the first ball members 410, and the second frame 320 may be in point contact with the first frame 310 by the second ball members 420. The camera module 10 configured as above may enable soft movement of the lens unit 300 due to relatively low friction resistance between the housing 110 and the first frame 310 and between the first frame 310 and the second frame 320. In addition, the dampers 500 may be formed between the lens unit 300 and the housing unit 100, thereby reducing collisions occurring between the lens unit 300 and the housing unit 100 due to external impacts.

Referring to FIG. 5, a scheme of reducing collision noise and/or damage by using the dampers 500 will be described. The dampers 500 may be configured to reduce collision energy and collision noise generated by rapid upward movement (direction with reference to FIG. 4) of the lens unit 300. For example, the dampers 500 may be disposed between the cover member 350, that is, a portion of the lens unit 300, and the shield can 120, that is, a portion of the housing unit 100, to reduce impacts and collision noise due to collisions between the cover member 350 and the shield can 120. That is, the dampers 500 may be modified in a manner in which an area of the damper 500 to come into contact with the cover member 350 is increased or a length of the damper 500 is reduced when the cover member 350 and the shield can 120 collide, whereby the contact time between the cover member 350 and the shield can 120 may be increased. Such an increase in contact time t may reduce intensity of force F with respect to impact energy (W=F*t) having a predetermined magnitude, whereby collision damage and/or noise as well as force F actually applied to the cover member 350 or the shield can 120 may be reduced.

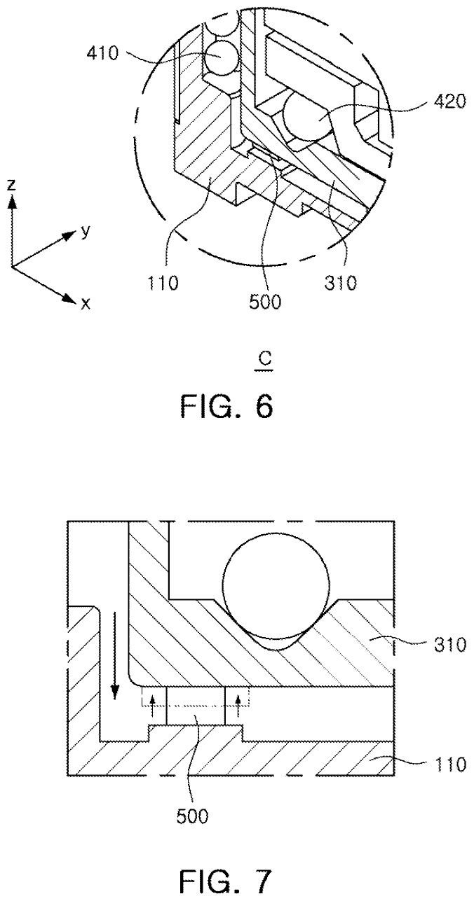

Referring to FIG. 6, portion C of the camera module 10 will be described. The damper 500 may be formed in a lower portion of the lens unit 300. For example, one or more dampers 500 may be formed between the first frame 310 of the lens unit 300 and the housing 110 of the housing unit 100. The dampers 500 disposed as above may reduce collision energy with the housing unit 100 due to rapid downward movement (direction with reference to FIG. 6) of the lens unit 300 and may reduce collision noise generated at the time of collisions.

Referring to FIG. 7, a scheme of reducing collision damage and/or noise by using the dampers 500 will be described. The dampers 500 may be configured to reduce collision energy and collision noise generated by rapid downward movement (direction with reference to FIG. 4) of the lens unit 300. For example, the dampers 500 may be disposed between the first frame 310, that is, a portion of the lens unit 300, and the housing 110, that is, a portion of the housing unit 100, to reduce impacts and collision noise generated due to collisions between the first frame 310 and the housing 110. That is, the dampers 500 may be modified in a manner in which an area of the damper 500 to come into contact with the first frame 310 is increased or a length of the damper 500 is reduced when the first frame 310 and the housing 110 collide, whereby contact time t between the first frame 310 and the housing 110 may be increased. Such an increase in contact time t may reduce intensity of force F with respect to impact energy (W=F*t) having a predetermined magnitude, whereby collision damage and/or noise as well as force F actually applied to the first frame 310 or the housing 110 may be reduced.

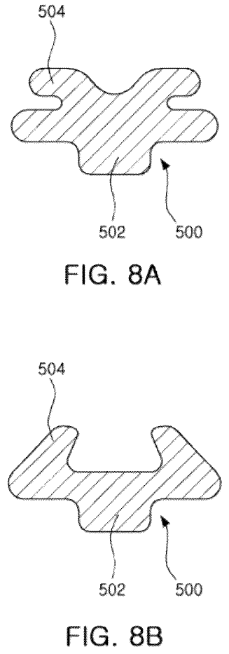

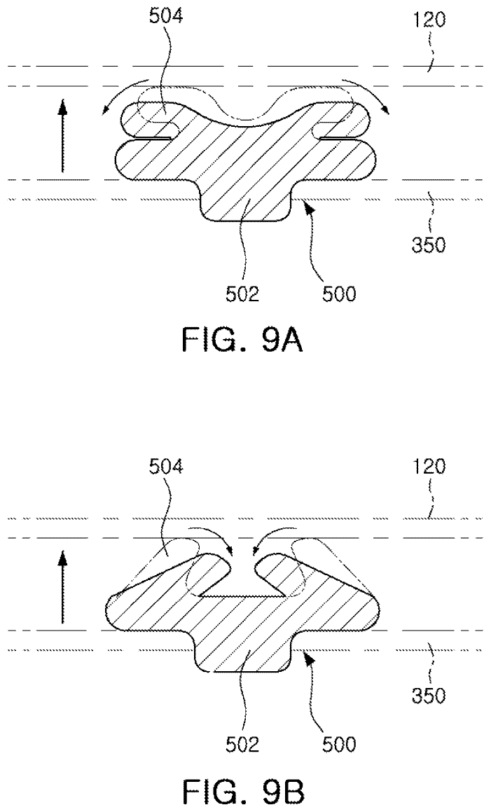

Referring to FIGS. 8A and 8B, other forms of dampers will be described. The damper 500 may be configured of a fixing unit 502 fixed to the lens unit 300 and a modification unit 504 to be modified by impacts. The fixing unit 502 may have a protruding shape insertable into the lens unit 300, and the modification unit 504 may be bent or compressed due to impacts. Referring to FIGS. 9A and 9B, a modified shape of the damper 500 due to impacts will be described. The damper 500 of FIG. 8A may be easily compressed due to impacts. For example, the damper 500 may be compressed due to collisions between the cover member 350 and the shield can 120 as illustrated in FIG. 9A, thereby reducing collision damage and/or noise. The damper 500 of FIG. 8B may be easily bent due to impacts. For example, the damper 500 may be bent due to collisions between the cover member 350 and the shield can 120 as illustrated in FIG. 9B, thereby reducing collision noise.

As discussed herein, the polymer composition of the present invention is particularly well suited for use in a damper of a camera module, such as one or more of the dampers 500 (including the fixing unit 502 and/or modification unit 504 shown in FIGS. 8A and 8B) shown in the figures and discussed above. Of course, as noted, the polymer composition may also be employed to form all or a portion of other components of the camera module 10, such as in the housing unit 100 (e.g., housing 110), actuator unit 200 (e.g., first coil 212, second coil 222, first actuator 210, second actuator 220, first substrate 216, second substrate 226, etc.), shield can 120, lens unit 300 (e.g., lens barrel 340, first frame 310, second frame 320, third frame 330, etc.), cover member 350, ball stopper 360, ball member 400 (e.g., ball members 410, 420, and/or 430), and so forth.

The present invention may be better understood with reference to the following examples.

### Test Methods

Melt Viscosity: The melt viscosity (Pa-s) may be determined in accordance with ISO 11443:2021 at a shear rate of 1,000 s⁻¹ or 400 s⁻¹ and temperature 15° C. above the melting temperature using a Dynisco LCR7001 capillary rheometer. The rheometer orifice (die) had a diameter of 1 mm, length of 20 mm, L/D ratio of 20.1, and an entrance angle of 180°. The diameter of the barrel was 9.55 mm+0.005 mm and the length of the rod was 233.4 mm.

Melting Temperature: The melting temperature (“Tm”) may be determined by differential scanning calorimetry (“DSC”) as is known in the art. The melting temperature is the differential scanning calorimetry (DSC) peak melt temperature as determined by ISO 11357-2:2020. Under the DSC procedure, samples were heated and cooled at 20° C. per minute as stated in ISO Standard 10350 using DSC measurements conducted on a TA Q2000 Instrument.

Deflection Temperature Under Load (“DTUL”): The deflection under load temperature may be determined in accordance with ISO 75-2:2013 (technically equivalent to ASTM D648-18). More particularly, a test strip sample having a length of 80 mm, thickness of 10 mm, and width of 4 mm may be subjected to an edgewise three-point bending test in which the specified load (maximum outer fibers stress) was 1.8 Megapascals. The specimen may be lowered into a silicone oil bath where the temperature is raised at 2° C. per minute until it deflects 0.25 mm (0.32 mm for ISO Test No. 75-2:2013).

Tensile Modulus, Tensile Stress, and Tensile Elongation: Tensile properties may be tested according to ISO 527:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 1 or 5 mm/min.

Flexural Modulus, Flexural Stress, and Flexural Elongation: Flexural properties may be tested according to ISO Test No. 178:2019 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO 179-1:2010) (technically equivalent to ASTM D256-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C.

Rockwell Hardness: Rockwell hardness is a measure of the indentation resistance of a material and may be determined in accordance with ASTM D785-08 (Scale M). Testing is performed by first forcing a steel ball indentor into the surface of a material using a specified minor load. The load is then increased to a specified major load and decreased back to the original minor load. The Rockwell hardness is a measure of the net increase in depth of the indentor, and is calculated by subtracting the penetration divided by the scale division from 130.

Scratch Resistance: Five (5) ISO tensile bars are formed from a particular sample. One of the tensile bars is held in hand like a pencil and rubbed back and forth 20 times against the surface of the other ISO tensile bars. For each bar, the scratch resistance is rated on a scale of 1 to 5, with a “5” rating means nearly no scratches and a “1” rating meaning numerous scratches. The average scratch resistance is then determined and recorded.

### Examples 1-5

Samples 1-5 are formed from various weight percentages of LCP 1, colorant, Impact Modifier 1, Mineral 1, and a lubricant, as shown in Table 1. LCP 1 is formed from 62.5 mol. % HBA, 5 mol. % HNA, 16.4 mol. % TA, 11.2 mol. % BP, and 5 mol. % APAP. Mineral 1 is barium sulfate particles having a median particle size of 4 micrometers. Impact Modifier 1 is a terpolymer of ethylene, n-butyl acrylate, and glycidyl methacrylate having a melt flow index of 12 g/10 min, Shore A hardness of 73 (equates to a Shore D hardness of about 23), a glycidyl methacrylate monomer content of about 5 wt. %, and a butyl acrylate content of about 28 wt. %.

TABLE 1

| Sample | 1 | 2 | 3 | 4 | 5 |
|---|---|---|---|---|---|
| LCP 1 | 54.2 | 48.2 | 43.2 | 58.2 | 68.2 |
| Lubricant | 0.3 | 0.3 | 0.3 | 0.3 | 0.3 |
| Colorant | 1.5 | 1.5 | 1.5 | 1.5 | 1.5 |
| Impact Modifier 1 | 4 | 10 | 15 | 10 | 10 |
| Mineral 1 | 40 | 40 | 40 | 30 | 20 |

Parts are injection molded from the samples of Examples 1-5 into plaques and tested for various thermal and mechanical properties. The results are set forth below in Table 2.

TABLE 2

| Sample | 1 | 2 | 3 | 4 | 5 |
|---|---|---|---|---|---|
| Melt Viscosity (Pa-s) at 400 s⁻¹) | 36 | 77 | 154 | 86 | 69 |
| Melt Viscosity (Pa-s) at 1000 s⁻¹) | 53 | 122 | 275 | 139 | 107 |
| Melting Temperature (° C.) | 331 | 331 | 332 | 331 | 333 |
| DTUL at 1.8 MPa (° C.) | 214 | 193 | 174 | 179 | 179 |
| Rockwell Surface Hardness | 46 | 31 | 32 | — | 22 |
| Charpy Unnotched (kJ/m²) | 15 | 14 | 9 | 23 | 63 |
| Charpy Notched (kJ/m²) | 62 | 75 | 54 | 85 | 106 |
| Tensile Strength (MPa) | 121 | 99 | 59 | 113 | 129 |
| Tensile Modulus (MPa) | 7,283 | 4,779 | 3,296 | 5,483 | 6149 |
| Tensile Elongation (%) | 5.14 | 6.23 | 4.26 | 5.26 | 4.83 |
| Flexural Strength (MPa) | 110 | 76 | 55 | 85 | 93 |
| Flexural Modulus (MPa) | 7,631 | 5,208 | 3,778 | 5,917 | 6,483 |
| Scratch Resistance Rating | 2 | 5 | 5 | 5 | 5 |

### Examples 6-10

Samples 6-10 are formed from various weight percentages of LOP 1, colorant, Impact Modifier 1, Mineral 1, and a lubricant, as shown in Table 3.

TABLE 3

| Sample | 6 | 7 | 8 | 9 | 10 |
|---|---|---|---|---|---|
| LCP 2 | 58.2 | 60.2 | 62.2 | 63.2 | 65.2 |
| Lubricant | 0.3 | 0.3 | 0.3 | 0.3 | 0.3 |
| Colorant | 1.5 | 1.5 | 1.5 | 1.5 | 1.5 |
| Impact Modifier 1 | 10 | 8 | 6 | 10 | 8 |
| Mineral 1 | 30 | 30 | 30 | 25 | 25 |

Parts are injection molded from the samples of Examples 6-10 into plaques and tested for various thermal and mechanical properties. The results are set forth below in Table 4.

TABLE 4

| Sample | 6 | 7 | 8 | 9 | 10 |
|---|---|---|---|---|---|
| Melt Viscosity (Pa-s) at 400 s⁻¹) | 58 | 41 | 39 | 66 | 45 |
| Melt Viscosity (Pa-s) at 1000 s⁻¹) | 88 | 58 | 56 | 100 | 63 |
| Melting Temperature (° C.) | 329.37 | 330.92 | 329.78 | 330.15 | 330.82 |
| DTUL at 1.8 MPa (° C.) | 207 | 211 | 212 | 207 | 212 |
| Rockwell Surface Hardness | 22 | 21 | 34 | 24 | 31 |
| Charpy Unnotched (kJ/m²) | 84 | 62 | 64 | 75 | 72 |
| Charpy Notched (kJ/m²) | 5.3 | 17 | 17 | 8.5 | 16 |
| Tensile Strength (MPa) | 110 | 122 | 119 | 108 | 111 |
| Tensile Modulus (MPa) | 5,368 | 5,973 | 6,480 | 5,364 | 5,948 |
| Tensile Elongation (%) | 5.95 | 6.32 | 4.96 | 5.5 | 5.07 |
| Flexural Strength (MPa) | 85 | 93 | 101 | 87 | 94 |
| Flexural Modulus (MPa) | 5,723 | 6,337 | 6,793 | 5,852 | 6,277 |
| Scratch Resistance Rating | 5 | 5 | 4 | 5 | 5 |

### Examples 11-17

Samples 11-17 are formed from various weight percentages of LOP 1, colorant, Impact Modifier 1, Mineral 1, Mineral 2, Mineral 3, and a lubricant, as shown in Table 5. Mineral 2 is wollastonite fibers (Nyglos® 8) and Mineral 3 is talc particles having a median particle diameter of 1.9 μm.

TABLE 5

| Sample | 11 | 12 | 13 | 14 | 15 | 16 | 17 |
|---|---|---|---|---|---|---|---|
| LCP 1 | 73.2 | 68.2 | 68.2 | 68.2 | 73.2 | 68.2 | 68.2 |
| Lubricant | 0.3 | 0.3 | 0.3 | 0.3 | 0.3 | 0.3 | 0.3 |
| Colorant | 1.5 | 1.5 | 1.5 | 1.5 | 1.5 | 1.5 | 1.5 |
| Impact Modifier 1 | 10 | 10 | 10 | 10 | 10 | 10 | 10 |
| Mineral 1 | 15 | — | — | 20 | 15 | — | — |
| Mineral 2 | — | 20 | — | — | — | 20 | — |
| Mineral 3 | — | — | 20 | — | — | — | 20 |

Parts are injection molded from the samples of Examples 11-17 into plaques and tested for various thermal and mechanical properties. The results are set forth below in Table 6.

TABLE 6

| Sample | 11 | 12 | 13 | 14 | 15 | 16 | 17 |
|---|---|---|---|---|---|---|---|
| Melt Viscosity (Pa-s) at 400 s⁻¹) | 56.7 | 91.7 | 75.5 | 64.9 | 68.6 | 101.5 | 78.7 |
| Melt Viscosity (Pa-s) at 1000 s⁻¹) | 81.9 | 150.8 | 116.5 | 100 | 111.3 | 165.8 | 123.4 |
| Melting Temperature (° C.) | 331.2 | 333.29 | 330.78 | 331.4 | 331.10 | 333.90 | 330.61 |
| DTUL at 1.8 MPa (° C.) | 219 | 216 | 218 | 210 | 209 | 212.4 | 214 |
| Rockwell Surface Hardness | 56 | 57 | 36 | 39 | 34 | 27.5 | 14.3 |
| Charpy Unnotched (kJ/m²) | 110 | 125 | 75 | 124 | 91 | 110.0 | 67 |
| Charpy Notched (kJ/m²) | 7.4 | 3.2 | 0.7 | 17.8 | 18.4 | 20.2 | 14.7 |
| Tensile Strength (MPa) | 123 | 141 | 131 | 133 | 118 | 130 | 110 |
| Tensile Modulus (MPa) | 7,141 | 7,764 | 7,338 | 6,453 | 6,139 | 7,508 | 6,713 |
| Tensile Elongation (%) | 4.1 | 5 | 6.1 | 5.6 | 5.43 | 5.69 | 5.14 |
| Flexural Strength (MPa) | 102 | 110 | 100 | 92.3 | 94 | 106.84 | 93.22 |
| Flexural Modulus (MPa) | 7,224 | 7,630 | 7,599 | 6,358 | 6,611 | 7,504 | 7,000 |
| Scratch Resistance Rating | 5 | 5 | 5 | 5 | 5 | 5 | 5 |

### Examples 18-22

Samples 18-22 are formed from various weight percentages of LOP 1, LOP 2, colorant, Impact Modifier 2, and Mineral 4, as shown in Table 7. LOP 2 is formed from 73 mol. % HBA and 27 mol. % HNA. Mineral 4 is talc particles having a median particle size of 7.5 μm. Impact Modifier 2 is a random copolymer of ethylene and glycidyl methacrylate having a melt flow index of 5 g/l 0 min, a Shore D hardness of about 50, and a glycidyl methacrylate monomer content of about 8 wt. %.

TABLE 7

| Sample | 18 | 19 | 20 | 21 | 22 |
|---|---|---|---|---|---|
| LCP 2 | 61.25 | 56.25 | 51.25 | 46.25 | 36.25 |
| Colorant | 3.75 | 3.75 | 3.75 | 3.75 | 3.75 |
| Impact Modifier 2 | 15 | 20 | 25 | 30 | 40 |
| Mineral 4 | 20 | 20 | 20 | 20 | 20 |

Parts are injection molded from the samples of Examples 18-21 into plaques and tested for various thermal and mechanical properties. The results are set forth below in Table 8.

TABLE 8

| Sample | 18 | 19 | 20 | 21 |
|---|---|---|---|---|
| DTUL at 1.8 MPa (° C.) | 134 | 124 | 104 | 93 |
| Rockwell Surface Hardness | 22 | 18 | 19 | 7.5 |
| Charpy Unnotched (kJ/m²) | 54 | 47 | 42 | 21 |
| Charpy Notched (kJ/m²) | 72 | 69.8 | 69.3 | 65 |
| Tensile Strength (MPa) | 98 | 89 | 78 | 45 |
| Tensile Modulus (MPa) | 5,483 | 4,972 | 4,141 | 3,123 |
| Tensile Elongation (%) | 5.79 | 5.58 | 5.86 | 3.26 |
| Flexural Strength (MPa) | 88 | 79 | 68 | 52 |
| Flexural Modulus (MPa) | 5,853 | 5,310 | 4,429 | 3,368 |
| Scratch Resistance Rating | 5 | 5 | 5 | 5 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A polymer composition comprising 100 parts by weight of a polymer matrix and from about 20 parts to about 150 parts by weight of an impact modifier, wherein the impact modifier includes a (meth)acrylic component that is derived from an epoxy-functionalized monomeric unit, non-epoxy functionalized (meth)acrylic monomeric component, or a combination thereof, further wherein the impact modifier exhibits a Shore D hardness of about 75 or less as determined in accordance with ISO 868:2003.

2. The polymer composition of claim 1, wherein the (meth)acrylic component is derived from an epoxy-functionalized (meth)acrylic monomeric component.

3. The polymer composition of claim 2, wherein the epoxy-functionalized (meth)acrylic monomeric component is formed from glycidyl acrylate, glycidyl methacrylate, or a combination thereof.

4. The polymer composition of claim 2, wherein the epoxy-functionalized (meth)acrylic monomeric component constitutes from about 1 wt. % to about 35 wt. % of the impact modifier.

5. The polymer composition of claim 2, wherein the (meth)acrylic component is also derived from a non-epoxy-functionalized (meth)acrylic monomeric component.

6. The polymer composition of claim 5, wherein the non-epoxy-functionalized (meth)acrylic monomeric component is formed from butyl acrylate, methyl acrylate, butyl methacrylate, methyl methacrylate, or a combination thereof.

7. The polymer composition of claim 5, wherein the non-epoxy-functionalized (meth)acrylic monomeric component constitutes from about 5 wt. % to about 40 wt. % of the polymer.

8. The polymer composition of claim 1, wherein the impact modifier further includes an α-olefin monomeric component.

9. The polymer composition of claim 1, wherein the (meth)acrylic component constitutes from about 5 wt. % to about 45 wt. % of the impact modifier.

10. The polymer composition of claim 1, wherein the (meth)acrylic component constitutes from about 20 wt. % to about 40 wt. % of the impact modifier.

11. The polymer composition of claim 1, wherein the polymer composition exhibits a tensile modulus of about 5,500 MPa or less and/or a tensile break strain of about 1% or more as determined in accordance with ISO 527:2019 at a temperature of 23° C.

12. The polymer composition of claim 1, wherein the polymer composition exhibits a flexural modulus of about 6,000 MPa or less as determined in accordance with ISO 178:2019 at 23° C.

13. The polymer composition of claim 1, wherein the polymer composition exhibits a melt viscosity of about 200 Pa-s or less as determined in accordance with ISO 11443:2021 at a shear rate of 1,000 seconds⁻¹ and temperature that is 15° C. higher than the melting temperature of the polymer composition.

14. The polymer composition of claim 1, wherein the polymer composition exhibits a Rockwell hardness of about 90 or less.

15. The polymer composition of claim 1, wherein the composition exhibits a Charpy notched impact strength of about 10 kJ/m² or more and/or a Charpy unnotched impact strength of about 5 kJ/m² or more, as determined in accordance with ISO 179-1:2010 at a temperature of 23° C.

16. The polymer composition of claim 1, wherein the liquid crystalline polymer contains repeating units derived from 4-hydroxybenzoic acid.

17. The polymer composition of claim 16, wherein the liquid crystalline polymer contains repeating units derived 4-hydroxybenzoic acid in an amount of from about 40 mol. % to about 82 mol. %.

18. The polymer composition of claim 16, wherein the liquid crystalline polymer further contains repeating units derived from 6-hydroxy-2-naphthoic acid, 2,6-naphthalenedicarboxylic acid, terephthalic acid, isophthalic acid, hydroquinone, 4,4′-biphenol, acetaminophen, or a combination thereof.

19. The polymer composition of claim 16, wherein the liquid crystalline polymer further contains repeating units derived from 6-hydroxy-2-naphthoic acid.

20. The polymer composition of claim 1, wherein the polymer composition has a melting temperature of from about 210° C. to about 360° C. as determined in accordance with ISO 11357-3:2018.

21. The polymer composition of claim 1, wherein the polymer matrix constitutes from about 30 wt. % to about 80 wt. % of the polymer composition and the impact modifier constitutes from about 15 wt. % to about 50 wt. % of the polymer composition.

22. The polymer composition of claim 1, further comprising an inorganic filler distributed within the polymer matrix.

23. The polymer composition of claim 22, wherein the inorganic filler includes talc, mica, barium sulfate, wollastonite, or a combination thereof.
